(19) United States
(12) Patent Application Publication
(10) Pub. No.: US 2024/0060580 A1
(43) Pub. Date: Feb. 22, 2024

(54) BIODEGRADABLE IRRIGATION PIPE

(71) Applicant: RIVULIS PLASTRO LTD., Kibbutz Gvat (IL)

(72) Inventors: Noam Kahani, Kibbutz Gvat (IL); Dotan Shmueli, Kibbutz Gvat (IL); Hadar Dafna Fisher, Kibbutz Gvat (IL); Sharbell Abboud, Kibbutz Gvat (IL)

(21) Appl. No.: 18/259,049

(22) PCT Filed: Jan. 5, 2022
(86) PCT No.: PCT/IL2022/050018

§ 371 Date: Jun. 22, 2023

(30) Foreign Application Priority Data
Jan. 6, 2021 (IL) 279997

(51) Int. Cl. F16L 9/18; A01G 25/02; F16L 9/01; F16L 9/14; F16L 9/17

(52) U.S. Cl. CPC F16L 9/18; A01G 25/023; F16L 9/01; F16L 9/14; F16L 9/17

(57) ABSTRACT

A multi-layered drip irrigation pipe wherein its core layer made from one of the materials selected from group of materials consisting of paper, paper pulp, board, sawdust, wood, wood chippings, bamboo, bagasse, oil palm stem, popula, wood flour, fruit hull powder, moss, peat, mulch, grasses, straw, hay, cotton, starch, seeds, seed husks, silage, cereal and cereal husks, kernels, bread, flour, skin, feces, manure, dung, fish cartilage, leaves of various flora, bark of various flora, plant stems, seaweed and other naturally growing flora, bone, bone meal, vegetables, fruit, fiber, hair, fur, feathers, clay, shell, ash, rags, felt and other commercially produced fabrics and mixtures of any of the preceding materials.

### FIELD

The various embodiments described herein generally relate to irrigation pipes for agricultural applications, and particularly drip irrigation pipes of a structure that is at least partly biodegradable and are at least mainly compostable, after a period of time.

### BACKGROUND

Agricultural irrigation systems comprised of infrastructure of water pipes and drip irrigation laterals that branch off from those pipes and are fed by them can become an environmental hazard after the end of their useful life (e.g. after the end of the growing season when the farming area needs to be cultivated for another and different crop) or once they wear out.

Polymeric raw materials from which ordinary irrigation pipes and drip irrigation laterals are made do not degrade quickly, resources and time are invested in collecting them from the field, and they are not easily recyclable.

Under these circumstances and in light of the growing environmental and recycling trends, the irrigation products industry has been exploring for years solutions for making irrigation pipes and drip emitter infrastructure from materials that are at least partly biodegradable and that are mainly compostable after a period of time once they are exposed in a deliberate and timed manner to a catalyst or mechanical damage to their structure (e.g. tearing or grinding that directly exposes their internal structure to environmental conditions) and leads to their rapid degradation.

The following patent publications are believed to represent the current state of the art:

U.S. Pat. No. 3,774,850 describes a tube for use in distributing water along the length of the tube. The tube having a plurality of outlets located along its length. Means securing walls of the tube together within the interior of the tube adjacent to each of the outlets so as to restrict the flow of water to each of the outlets from the interior of the tube. The tube is described as being formed of an impervious material which can be a biodegradable composition capable of being broken up by an agricultural implement, and the disclosure further point to organic polymer composition disclosed in U.S. Pat. No. 3,590,528 entitled, “Decomposable Polybutene-1 Agricultural Mulch Film” while already considered at that time, that many other biodegradable polymers and compositions are known and are currently being developed in response to an increasing public demand for polymers which do not present any significant disposability problem.

U.S. Pat. No. 4,474,330 describes an irrigation conduit comprising an extruded tube having a peripheral wall and at least one elongated passage and an elongated supply tube having an elongated supply passage. The supply tube is formed of sheet material joined together along longitudinally extending portions to form a seam. A region of the sheet material extends at least part way around the perimeter of the extruded tube, and the extruded tube is retained on such region of the sheet material. Transfer ports extend between the passages of the two tubes and discharge ports extend from the passage of the extruded tube to the exterior of the irrigation conduit. The supply tube can be formed from a variety of materials, including thin film plastics and paper, and one of the embodiments (see FIG. 6) describes the sheet material as constructed of a laminate which comprises a layer of biodegradable paper sandwiched between an inner layer and an outer layer of extremely thin substantially impervious film plastic.

U.S. Pat. No. 4,880,167 describes turbulent-flow emitter channel sections that are vacuum-formed in an extruded flat plastic strip. The strip is then applied to a hose substrate. In one of the embodiments (see there FIGS. 7 and 8), the patent describes the hose-forming substrate as being composed of a layer of paper or other biodegradable material coated on each side with a layer of a waterproof material such as plastic.

U.S. Pat. No. 8,726,565 describes a sheet mulch assembly includes a sheet mulch; an irrigation conduit attached to and carried by the sheet mulch; and at least one carrier substrate coupled with the conduit. Each carrier substrate carries at least one seed. The sheet mulch being described as biodegradable or non-biodegradable. For example, the sheet mulch can be formed from cellulose, cellulose derivatives, or plastic. The irrigation conduit being defined as drip tape preferably formed from a biodegradable plastic wherein examples of such plastics include polymeric and polyester materials of many specific types. The seed carrier substrate is described as a tape that may be formed from a biodegradable material, such as unseized Kraft paper.

U.S. Pat. No. 7,862,873 describes an irrigation pipe having a wall comprising: a core layer formed from a biodegradable material; and at least one relatively non-biodegradable protective layer formed on the core layer. The core layer is formed from at least one material from the group of materials consisting of: polylactic acid; modified polylactic acid; plasticised polylactic acid; polylactic acid copolymers; starch copolymer; thermoplastic starch; PHA; polymerized seed oil; an aliphatic polyester polymer; and/or an aliphatic/aromatic polyester copolymer.

U.S. Pat. Application Publication No. US2010/0084491 describes a stick in (to the ground) type of irrigation device comprising: a connector end for engagement with a liquid supply; and, a biodegradable dispenser body adapted to receive liquid from the connector end, wherein an outer surface of the dispenser body is substantially water-resistant with the exception of one or more permeable feeder areas from which liquid can be released at a higher rate than from the water-resistant areas. The substrate used to form the biodegradable dispenser body is described as including one or more biodegradable materials, such as fibreboard material, which is folded or wrapped and then sealed or fastened into a suitable shape and configuration. The substrate may be constructed from natural or man-made materials. Such materials may be virgin or recycled. The substrate is preferably formed from byproduct and/or waste materials. Preferably, the substrate comprises material selected from the group consisting of paper, paper pulp, board, sawdust, wood, wood chippings, bamboo, bagasse, oil palm stem, popula, wood flour, fruit hull powder, moss, peat, mulch, grasses, straw, hay, cotton, starch, seeds, seed husks, silage, cereal and cereal husks, kernels, bread, flour, skin, feces, manure, dung, fish cartilage, leaves of various flora, bark of various flora, plant stems, seaweed and other naturally growing flora, bone, bone meal, vegetables, fruit, fiber, hair, fur, feathers, clay, shell, ash, rags, felt and other commercially produced fabrics and mixtures of any of the preceding materials. Starch is described as a preferred substrate material. Starch can be selected from natural starch, chemically and/or physically modified starch, biotechnologically produced and/or genetically modified starch and mixtures thereof. The term “starch” as used in the publication covers in general all the starches of natural or vegetable origin composed essentially of amylose and amylopectin. They can be extracted from various plants, such as, for example, potatoes, rice, tapioca, maize and cereals such as rye, oats and wheat. The term “starch” also covers modified starches. By modified, it is meant that the starch can be derivatized or modified by typical processes known in the art such as, e.g. esterification, etherification, oxidation, acid hydrolysis, cross-linking, and enzyme conversion. Such starches include starch ethoxylates, starch acetates, cationic starches, oxidized starches, cross-linked starches and the like.

U.S. Pat. Application Publication No. US2009/224078 describes an agricultural irrigation assembly, comprising: a water supply header; a plurality of drip tapes fluidly coupled with said supply header, each said drip tape consisting essentially of a biodegradable plastic material consists essentially of a polyhydroxyalkanoate (PHA) polymer.; and a catalyst dispenser in fluid communication with said supply header, said dispenser containing a catalyst that essentially consists of one of a chemical and an enzyme for initiating fast degradation of said biodegradable plastic material.

U.S. Pat. No. 8,714,205 describes a delayed degradability drip irrigation pipe including a water conduit at a water conduit pressure and a plurality of drip irrigation outlets, each communicating with the water conduit and providing a water output at a pressure below the water conduit pressure, at least the water conduit being formed at least partially of a degradable material and also including a degradability delayer which provides a desired delay prior to failure of the water conduit but permits eventual degradation of the degradable material under predetermined conditions. The irrigation pipe is described as preferably formed of a biodegradable plastic material, such as PBAT (polybutylene adipate/teraphthalate), PTMAT (polymethylene adipate/teraphthalate), naturally produced polyester, such as PHA polyesters (polyhydroxyalkanoates), PHBH polyesters (poly-hydroxybutyrate-co-polyhydroxy hexanoates) and PLA polyesters (polylactic acid), which is biodegradable by bacterial and/or fungal action.

The obvious conclusion to be drawn from the above-cited prior art is that prior to the invention that is the subject of the Patent Application, a solution had not been found for drip irrigation laterals, which are the type of pipes along which discrete drip emitters are spaced from each other as a means of each enabling the reduction of the water pressure in the pipe/lateral, so that the water that emits from each of these discrete means to the designated area for irrigation will be in the form of droplets, and wherein the structure of the lateral, including the discrete drip emitters contained therein, will minimize the need for using polymers and will enable the desired degradation of the lateral.

### SUMMARY OF THE INVENTION

The invention that is the subject of the Patent Application presents a solution to the challenge presented in the background chapter of the invention. That is, the invention teaches drip irrigation laterals that are the type of pipes along which discrete drip emitters are spaced from each other, each of which enable the reduction of the water pressure in the lateral/pipe, so that the water that emits from each one of these means to the designated area for irrigation, will be in the form of a droplet, and wherein the structure of the lateral according to the invention, including the discrete drip emitters in them, minimizes the need for using polymers and enables the desired degradation of the lateral.

Aspects and embodiments are directed to a drip irrigation lateral comprising a pipe of which its wall is a multi-layered wall having a core layer. A plurality of discrete drip emitters that are disposed along the pipe, inside it (as opposed to on its exterior), each of which enables reducing the water pressure inside the pipe, so that the water emitted from each of these discrete drip emitters to the designated irrigation area will be in the form of a droplet. According to the invention, the core layer is characterized in that it is made of a material selected from a group of materials consisting of paper, paper pulp, board, sawdust, wood, wood chippings, bamboo, bagasse, oil palm stem, popula, wood flour, fruit hull powder, moss, peat, mulch, grasses, straw, hay, cotton, starch, seeds, seed husks, silage, cereal and cereal husks, kernels, bread, flour, skin, feces, manure, dung, fish cartilage, leaves of various flora, bark of various flora, plant stems, seaweed and other naturally growing flora, bone, bone meal, vegetables, fruit, fiber, hair, fur, feathers, clay, shell, ash, rags, felt and other commercially produced fabrics and mixtures of any of the preceding materials

According to another embodiment the invention is embodied in an irrigation system that comprises a plurality of drip irrigation laterals, as described above, and in addition a feeding pipe to which the laterals are connected to a water flow passage from it to them. The feeding pipe may also be a pipe having a multi-layered wall and comprising a core layer, characterized in that it is made of a material selected from the above-specified group of materials suitable for a drip irrigation lateral according to the invention (although in most scenarios, the feeding pipe is multi-seasonal, collectible, and therefore does not have to be degradable/decomposable).

Still other aspects, embodiments, and advantages of these exemplary aspects and embodiment are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE FIGURES

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a perspective illustration of an example of an irrigation system according to the invention, which comprises drip irrigation laterals that are fed with water from a feeding pipe and enlarged parts thereof.

FIGS. 2a-2e depict in perspective views and enlarged parts inside it, various examples of drip irrigation laterals according to the invention.

### DETAILED DESCRIPTION OF EMBODIMENTS

Various apparatuses will be described below to provide an example of an embodiment of each claimed invention. No embodiment described below limits any claimed invention and any claimed invention may cover apparatuses that differ from those described below. The claimed inventions are not limited to apparatuses having all of the features of any one apparatus described below or to features common to multiple or all of the apparatuses described below. It is possible that an apparatus described below is not an embodiment of any claimed invention. Any invention disclosed in an apparatus deserted below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements, in addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Aspects and embodiments are directed to drip irrigation laterals that are the type of pipes along which discrete drip emitters are spaced from each other, each of which enable the reduction of the water pressure in the pipe, so that the water that emits from of these means to the designated irrigation area, will be in the form of a droplet, wherein the structure of a lateral according to the invention, including the discrete drip emitters in it, minimizes the need for using polymers and enables the desired degradation/decomposition of the lateral.

In particular, aspects and embodiments provide for such drip irrigation laterals, either discretely or in combination with a feeding pipe. That is, as an irrigation system in which the pipe components of the laterals are at the very least based on pipes having a multi-layered wall and comprising a core layer that is characterized in that it is made of one of the materials selected from the above group of materials. As stated, the feeding pipe pope in this irrigation system may also be a pipe having a multi-layered wall and comprising a core layer, characterized in that it is made of a material selected from the above-specified group of materials suitable for a drip irrigation lateral according to the invention (although in most scenarios, the feeding pipe is multi-seasonal, collectible, and therefore does not have to be degradable/decomposable).

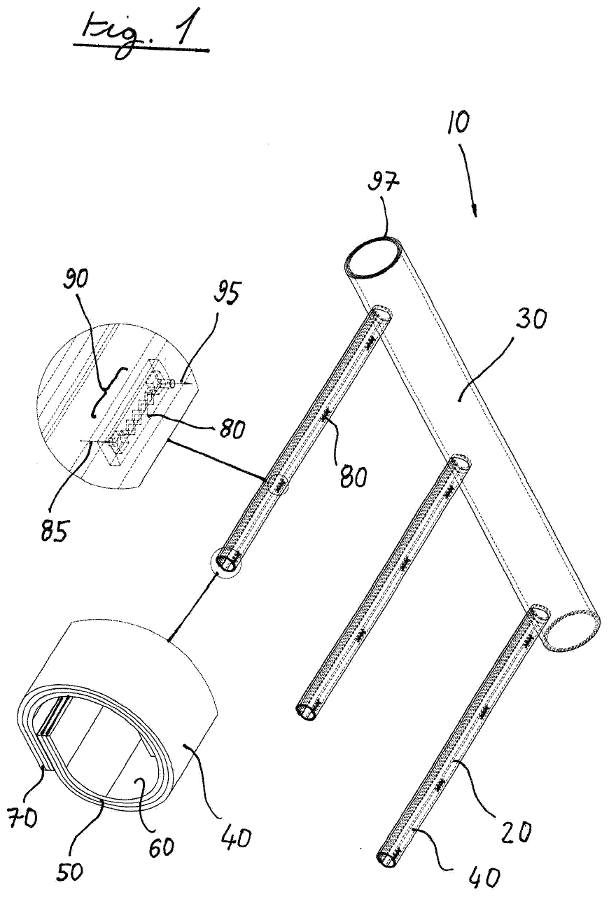

Reference is made to FIG. 1. FIG. 1 is a perspective illustration of an example of irrigation system 10 according to the invention, comprising plurality of drip irrigation laterals 20 fed with water from feeding pipe 30.

According to the illustrated example, drip irrigation lateral 20 each comprise pipe 40 having a multi-layered wall (see enlarged segment in the figure). The multi-layered wall comprises core layer 50, and according to the illustrated example, inner layer 60 which comes into contact with the water flowing in pipe 40 and outer layer 70, wherein core layer 50 is sandwiched between inner layer 60 and outer layer 70.

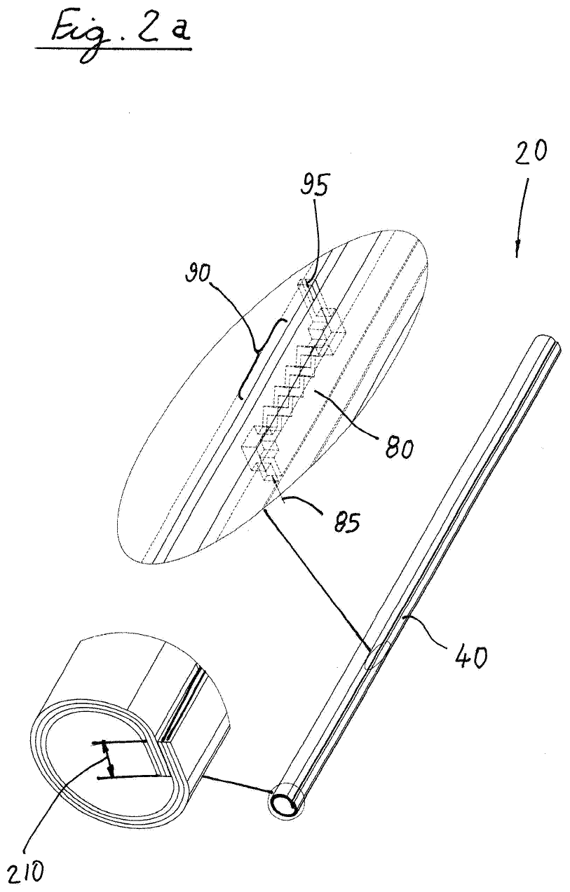

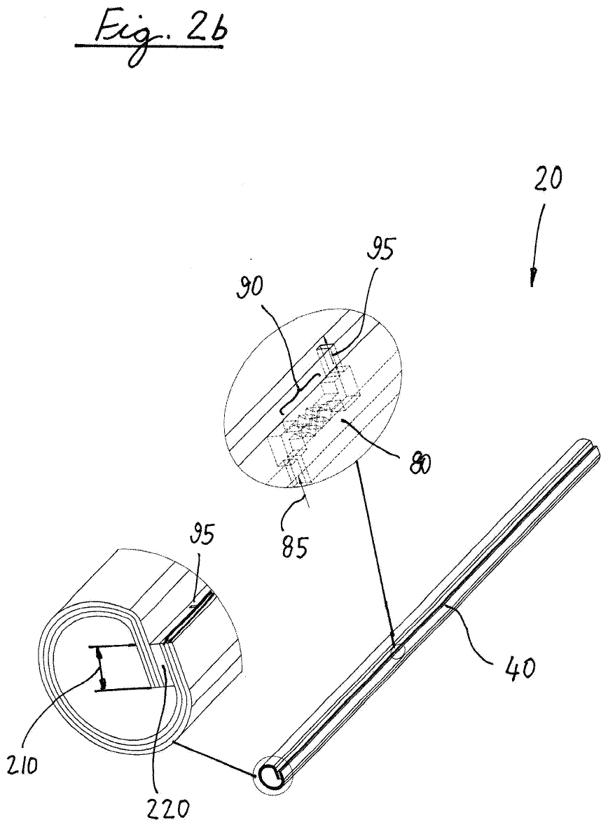

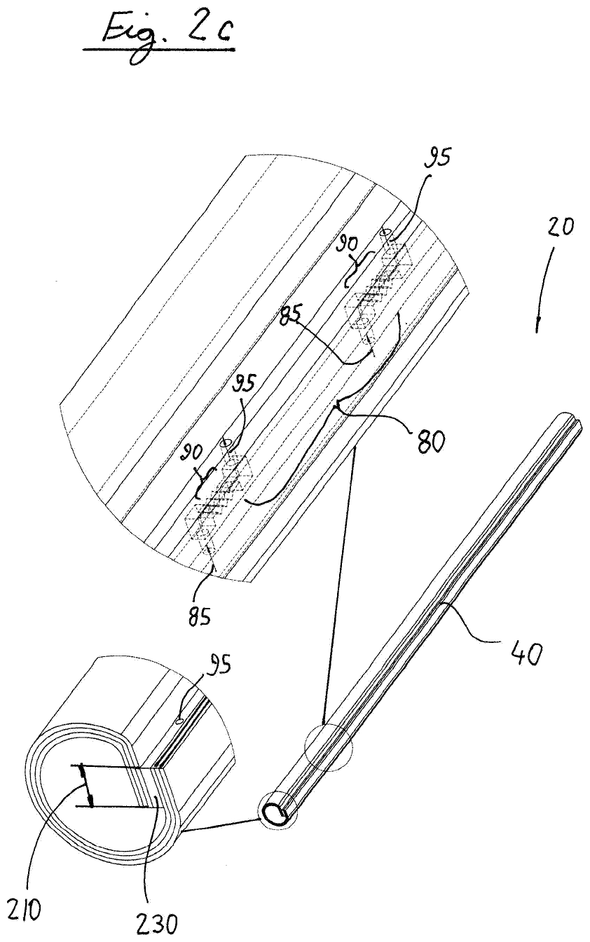

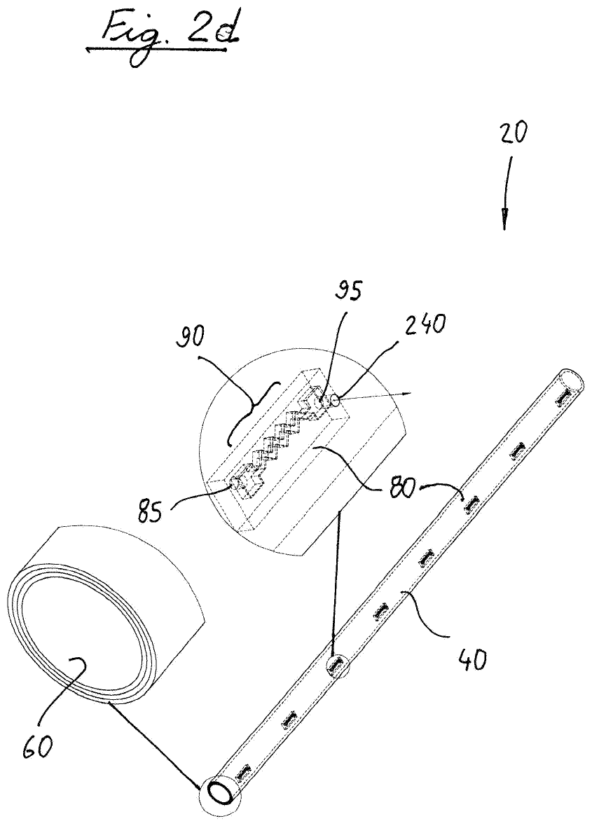

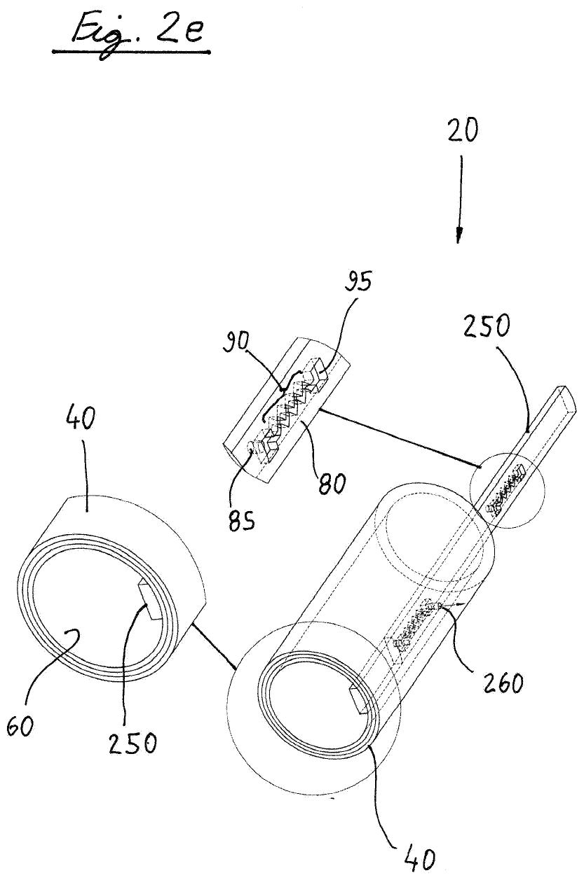

According to the illustrated example, pipe 40 is made of a multi-layered sheet that is folded into a pipe shape and connected along its entire length by an overlapping seam (by gluing, thermal welding or ultrasonic soldering, etc. and other such means known in the art). However, a person skilled in the art will understand that such a pipe may be manufactured by other and different methods (for example—by extrusion), (see below in reference to FIGS. 2a-2e).

Along each of pipes 40 and inside each one (as opposed to its exterior), according to the illustrated example, drip emitters 80 are disposed in an integral configuration (i.e.—placed inside the pipe, i.e.—these are discrete means that are placed along the inside of pipe 40, spaced apart from each other, and each enable the reduction of water in the lateral, whereby water emitted from each of the discrete means to the designated irrigation area will be in the form of a droplet.

A typical and familiar structure of a drip emitter 80 may be one that comprises (see enlarged segment in the figure) water inlet opening 85, which allows water to enter the drip emitter from inside the pipe, water pressure reduction means 90, which communicates with the flow of water into water inlet opening 85, and is formed, for example, in a baffle labyrinth configuration, and water outlet opening 95, which communicates with the flow of water whose pressure has been reduced by means 90 for reducing water pressure and outside from it to the designated irrigation area.

A skilled person will understand that other and different drip emitters may be embodied in the drip irrigation lateral according to the invention. Thus, for example, a drip emitter that is formed with an elongated water passage without barriers and not in a baffle labyrinth configuration, as a means for reducing the water pressure, may also be used as a discrete means allowing for the reduction of water pressure inside the lateral, whereby the water emitted from it to the designated irrigation area will be in the form of droplets. A skilled person will also understand that drip emitters inside a drip irrigation lateral according to the invention may be formed with a filter for filtering the inflowing water (thereby minimizing the risk of clogging), as well as pressure-regulated drip emitters.

According to the invention, core layer 50 is characterized in that it is made of one of the materials selected from the group of materials consisting of paper, paper pulp, board, sawdust, wood, wood chippings, bamboo, bagasse, oil palm stem, popula, wood flour, fruit hull powder, moss, peat, mulch, grasses, straw, hay, cotton, starch, seeds, seed husks, silage, cereal and cereal husks, kernels, bread, flour, skin, feces, manure, dung, fish cartilage, leaves of various flora, bark of various flora, plant stems, seaweed and other naturally growing flora, bone, bone meal, vegetables, fruit, fiber, hair, fur, feathers, clay, shell, ash, rags, felt and other commercially produced fabrics and mixtures of any of the preceding materials

As noted, according to the illustrated example, the multi-layered wall of pipe 40 comprises inner layer 60, which comes into contact with the water flowing in the pipe, and outer layer 70, wherein the core layer is sandwiched between the inner layer and the outer layer. The inner and outer layers are characterized in that they are made of a polymeric material that also degrades over time.

A skilled person will understand that the multi-layered pipe component in a drip irrigation lateral according to the invention can also be manufactured in other and different configurations. For example, as a double-layered pipe, wherein the core layer is in fact also the outer layer; as a multi-layered pipe whose inner layer or outer layer, or both, are not made of a biodegradable polymer; or as a pipe wherein all of its layers or some are comprised of multiple sub-layers, including one or more woven layers.

According to the illustrated example, feeding pipe 30 to which laterals 20 communicates with the flow passage from it to them, is also a multi-layered pipe comprised of core layer 97, which is characterized in that it is made of one of the materials from the above group of materials suitable for the core layers of laterals 40. Similarly, the multi-layered wall of feeding pipe 30 may also be comprised of an inner lay that comes into contact with the water flowing in the pipe wherein the core layer is sandwiched between the inner and outer layers. The inner and outer layers of feeding pipe 30 are also characterized in that they are made of a polymeric material that also is degradable in the course of time.

A skilled person will understand that the list of materials for manufacturing the components of core 50 of the drip lateral (as well as the component of core 97 of a feeding pipe pipe), as set out above, is not a closed list. For example, the source of the materials listed above may be made from natural or man-made materials (as a byproduct and/or as a recycled material). The core components may also be comprised of other materials and additives (provided that a substantial portion of the core is made from the above materials). An example of materials and additives are plasticizers, lubricants, and bonding agents. The manufacturing processes of the core may include mixing and applying pressure and heating.

As for the components of the inner and outer layers, biodegradable polymers that may be used include a range of water-resistant natural polymers, synthetic polymers, such as polyesters, polyester amides, polycarbonates and the like, and naturally-derived semi-synthetic polyesters (e.g. from fermentation) non-hydrocarbon based biodegradable plastic can be utilized for producing the inner and outer layers. Without limitation, examples of biodegradable plastics include polymeric and polyester materials of many specific types preferably formed from a polyhydroxyalkanoate (PHA) polymer. As further examples of biodegradable plastics, the inner and outer layers can also be formed from a poly (3-hydroxybutyrate) (P3HB) polyester, polyhydroxyalkanoates, poly (k-caprolactone), poly (l-lactide), and both aliphatic and aromatic polyalkylene dicarboxylic acids.

Reference is made to FIGS. 2a-2e. FIGS. 2a-2e depict in perspective views and enlarged parts inside it, various examples of drip irrigation laterals 20 according to the invention.

FIG. 2a depicts pipe 40 as made from a multi-layered sheet that is folded to form the pipe-like configuration of the pipe, and is connected in an overlapping seam configuration 210 along its length (e.g., by thermal welding, gluing, ultrasonic welding and by any other means known in the art). In the illustrated configuration, drip emitters 80 are formed by being embossed by impression into the wall of pipe 40 in the area of overlapping seam 210, as discrete means that are spaced apart from each other, in such a way that after folding the sheet into a pipe-like configuration, the overlapping multi-layered sheet encloses water inlet openings 85, water pressure reduction means 90 and water outlet openings 95 of each of the drip emitters, which are formed as stated by being embossed into the multi-layered wall of the pipe.

FIG. 2b also depicts pipe 40 as made from a multi-layered sheet that is folded to form the pipe-like configuration of the pipe, and is connected in an overlapping seam configuration 210 along its length (e.g., by thermal welding, gluing, ultrasonic welding and by any other means known in the art). In the illustrated configuration, overlapping seam 210 is also comprised of polymeric layer 220, which is added by thermal casting between the overlapping multi-layered sheet into the segment (section or portion) of the sheet that is overlapped by it, at least in places where drip emitters need to be formed (as discrete means). In the illustrated configuration, drip emitters 80 are formed by being embossed by impression into the added thermal polymeric layer 220, in such a way that after folding the sheet into a pipe-like configuration, the overlapping multi-layered sheet encloses water inlet openings 85, water pressure reduction means 90 and water outlet openings 95 of each of the drip emitters, which are formed as stated by being embossed into the added thermal polymeric layer 220.

FIG. 2c also depicts pipe 40 as made from a multi-layered sheet that is folded to form the pipe-like configuration of the pipe, in overlapping seam configuration 210 running along its length. In the illustrated configuration, overlap seam 210 also comprises strip 230 made of a polymeric material. Strip 230 is prefabricated and added between the overlapping multi-layer sheet and the section of the sheet that is overlapped by it, and is connected to the sheet on both sides (e.g. by thermal welding, gluing, ultrasonic welding and other such means known in the art). In the illustrated configuration, drip emitters 80 are formed from the outset in strip 230 as discrete means, spaced apart from each other, in such a way that after folding the sheet into a pipe-like configuration, the overlapping multi-layered sheet encloses water inlet openings 85, water pressure reduction means 90 and water outlet openings 95 that are formed in the added strip.

FIG. 2d depicts pipe 40 as made in said multi-layered configuration as stated by a continuous extrusion process that involves extruding the pipe's layers one after the other, one on top of the other (i.e.—in a pipe-like configuration without an overlapping seam). Similar to the illustration in FIG. 1, drip emitters 80 are placed as discrete means spaced apart from each other along the inner layer 60 of the pipe (e.g. by thermal welding, gluing, ultrasonic welding and other such means known in the art), in such a way that the inner layer encloses water inlet opening 85, water pressure reduction means 90 and water outlet openings 95 of the drip emitters (the discrete means), and wherein the pipe is additionally formed with openings 240 that communicate with the flow of water through them from water outlet openings 95 of drip emitters 80 and from them to the designated irrigation area.

FIG. 2e also depicts pipe 40 as made in said multi-layered configuration by a continuous extrusion process that involves extruding the layers one after the other, one on top of the other (i.e.—in a pipe-like configuration without an overlapping seam). In the illustrated configuration, pipe 40 also comprises strip 250 made of a polymeric material. Strip 250 is prefabricated and adapted for installation along inner layer 60 of the pipe (e.g. by thermal welding, gluing, ultrasonic welding and other such means known in the art), in such a way that the inner layer encloses water inlet opening 85, water pressure reduction means 90 and water outlet openings 95 of the drip emitters (the discrete means), which are formed from the outset in strip 250, and wherein the pipe is additionally formed with openings 260 that communicate with the flow of water through them from water outlet openings 95 of drip emitters 85, which as stated are formed from the outset on strip 250, and from them to the designated irrigation area.

Therefore, the invention as described above with reference to the accompanying figures, presents a solution for the need for drip irrigation laterals along which discrete means are disposed, spaced apart from each, and each of which facilitates the reduction of the water pressure in the lateral, so that the water that emits from each of these discrete means to the designated area for irrigation will be in the form of droplets, and wherein the structure of the lateral, including the drip emitters in them, will minimize the need for using polymeric materials and will enable the desired degradation of the lateral.

The expected degradation/decomposition time of the irrigation laterals according to the invention can be estimated according to the types of materials used in their manufacture, the relative thickness of the various layers, environmental conditions, and the possibility of speeding up the degradation/decomposition process by increased exposure of the materials from which the laterals are made to environmental conditions (e.g. by collecting the laterals and grinding them at designated recycling sites, intentionally tearing them in the field (manually or by mechanical means) and leaving them there, or by injecting a catalyst into the laterals).

While the Applicant's teachings are described herein in conjunction with various embodiments for illustrative purposes, it is not intended that the Applicant's teachings be limited to such embodiments. On the contrary, the applicant's teachings described and illustrated herein encompass various alternatives, modifications, and equivalents, without departing from the embodiments, the general scope of which is defined in the appended claims.

1. A drip irrigation lateral that comprises:
a pipe comprising a multi-layered wall and a core layer;
a plurality of drip emitters as discrete means that are disposed along and inside of said pipe, and spaced apart from each other, each of which enables reducing the water pressure inside the pipe, so that the water emitted from each of said drip emitters to the designated irrigation area will be in the form of droplets; and
wherein said core layer is made from one of the materials selected from the group of materials consisting of paper, paper pulp, board, sawdust, wood, wood chippings, bamboo, bagasse, oil palm stem, popula, wood flour, fruit hull powder, moss, peat, mulch, grasses, straw, hay, cotton, starch, seeds, seed husks, silage, cereal and cereal husks, kernels, bread, flour, skin, feces, manure, dung, fish cartilage, leaves of various flora, bark of various flora, plant stems, seaweed and other naturally growing flora, bone, bone meal, vegetables, fruit, fiber, hair, fur, feathers, clay, shell, ash, rags, felt and other commercially produced fabrics and mixtures of any of the preceding materials.

2. The drip irrigation lateral according to claim 1, wherein
said multi-layered wall of said pipe comprises an inner layer that comes in contact with the water flowing inside said pipe; and
an outer layer; and
wherein said core layer is sandwiched between said inner layer and the outer layer; and
wherein said inner and outer layers are characterized in that they are made of a polymeric material that degrades/decomposes over the course of time.

3. The drip irrigation lateral according to claim 1, wherein
said pipe is made of a multi-layered sheet that is folded for forming the pipe-like configuration of said pipe and is connected in an overlapping seam configuration along its length.

4. The drip irrigation lateral according to claim 1, wherein
said pipe is made in said multi-layered configuration by a continuous extrusion process that involves extruding said layers one after the other, one on top of the other.

5. The drip irrigation lateral according to claim 1, wherein
each of said drip emitters is comprised of:
a water inlet opening that allows for the entry of water into the drip emitter from inside the pipe; and
a water pressure reduction means that communicates with the flow of water inside the water pressure reduction means from said water inlet opening, and the water pressure reduction means is formed in a baffle labyrinth configuration; and
a water outlet opening that communicates with the flow of water whose pressure has been reduced, from said water pressure reduction means and outside from the water outlet opening to the designated irrigation area.

6. The drip irrigation lateral according to claim 3, wherein
each of said drip emitters is comprised of:
a water inlet opening that allows for the entry of water into said drip emitter from inside the pipe; and
a water pressure reduction means that communicates with the flow of water inside the water pressure reduction means from said water inlet opening, and the water pressure reduction means is formed in a baffle labyrinth configuration; and
a water outlet opening that communicates with the flow of water whose pressure has been reduced, from said water pressure reduction means and outside from the water outlet opening to the designated irrigation area; and wherein
said drip emitters are formed by being embossed into the wall of said pipe in the area of said overlapping seam in such a way that after said folding, the overlapping multi-layered sheet encloses said water inlet openings, water pressure reduction means and water outlet openings.

7. The drip irrigation lateral according to claim 3, wherein
each of the said drip emitters is comprised of:
a water inlet opening that allows for the entry of water into said drip emitter from inside the pipe; and
a water pressure reduction means that communicates with the flow of water inside the water pressure reduction means from said water inlet opening, and the water pressure reduction means is formed in a baffle labyrinth configuration; and
a water outlet opening that communicates with the flow of water whose pressure has been reduced, from said water pressure reduction means and outside the water outlet opening to the designated irrigation area; and wherein said overlapping seam is additionally comprised of a polymeric layer, which is added by thermal casting between the overlapping multi-layered sheet and the section of the sheet that is overlapped by it; and
wherein said drip emitters are formed by being embossed into said added thermal polymeric layer, in such a way that after said folding, the overlapping multi-layered sheet encloses said water inlet openings, water pressure reduction means and water outlet openings, which are formed as stated in the added thermal polymeric layer.

8. The drip irrigation lateral according to claim 3, wherein
each of said drip emitters is comprised of:
a water inlet opening that allows for the entry of water into said drip emitter from inside the pipe; and
a water pressure reduction means that communicates with the flow of water inside the water pressure reduction means from said water inlet opening, and the water pressure reduction means is formed in a baffle labyrinth configuration; and
a water outlet opening that communicates with the flow of water whose pressure has been reduced, from said water pressure reduction means and outside the water outlet opening to the designated irrigation area; and wherein
said overlapping seam additionally comprises a strip made of a polymeric layer, which is added between the overlapping multi-layered sheet and said section of the sheet that is overlapped by it; and
wherein said drip emitters are formed from the outset in said prefabricated strip in such a way that after said folding, the overlapping multi-layered sheet encloses said water inlet openings, water pressure reduction means and water outlet openings that are formed in said prefabricated added strip.

9. The drip irrigation lateral according to claim 4, wherein
each of said drip emitters is comprised of:
a water inlet opening that allows for the entry of water into said drip emitter from inside the pipe; and
a water pressure reduction means that communicates with the flow of water inside the water pressure reduction means from said water inlet opening, and the water pressure reduction means is formed in a baffle labyrinth configuration; and
a water outlet opening that communicates with the flow of water whose pressure has been reduced, from said water pressure reduction means and outside it; and wherein
said drip emitters are disposed along the inner wall of said pipe, in such a way that said wall encloses said water inlet openings, water pressure reduction means and water outlet openings; and
wherein said pipe is additionally formed with openings that communicate with the passage of water through them from said water outlet openings of said drip emitters and from them to the designated irrigation area.

10. The drip irrigation lateral according to claim 4, wherein—
each of said drip emitters is comprised of:
a water inlet opening that allows for the entry of water into the drip emitter from inside the pipe; and
a water pressure reduction means that communicates with the flow of water inside the water pressure reduction means from said water inlet opening, and the water pressure reduction means is formed in a baffle labyrinth configuration; and
a water outlet opening that communicates with the flow of water whose pressure has been reduced, from said water pressure reduction means and outside it; and wherein
said pipe additionally comprises a strip made of a polymeric material in which the said drip emitters are formed therein from the outset, and the said strip is adapted for installation along the inner wall of the said pipe, whereby said wall encloses the said water inlet openings, the water pressure reduction means and the water outlet openings; and
wherein said pipe is additionally formed with openings that communicated with the passage of water through them from said water outlet openings of said drip emitters and from them to the designated irrigation area.

11. The irrigation system that comprises of:
a plurality of drip irrigation laterals according to claim 1; and
a feeding pipe to which said laterals are connected to a flow passage from the feeding pipe to said laterals.

12. The irrigation system according to claim 11, wherein said feeding pipe comprises a multi-layered wall and a core layer made of a material selected from.

13. The irrigation system according to claim 12, wherein said core layer comprises the group of materials consisting of: paper, paper pulp, board, sawdust, wood, wood chippings, bamboo, bagasse, oil palm stem, popula, wood flour, fruit hull powder, moss, peat, mulch, grasses, straw, hay, cotton, starch, seeds, seed husks, silage, cereal and cereal husks, kernels, bread, flour, skin, feces, manure, dung, fish cartilage, leaves of various flora, bark of various flora, plant stems, seaweed and other naturally growing flora, bone, bone meal, vegetables, fruit, fiber, hair, fur, feathers, clay, shell, ash, rags, felt and other commercially produced fabrics and mixtures of any of the preceding materials.
